(19) United States
(12) Patent Application Publication
(10) Pub. No.: US 2017/0109794 A1
(43) Pub. Date: Apr. 20, 2017

(54) Content Targeting and Recommendations Based on Object Usage

(71) Applicant: Adobe Systems Incorporated, San Jose, CA (US)

(72) Inventors: Kevin Gary Smith, Lehi, UT (US); William Brandon George, Pleasant Grove, UT (US)

(21) Appl. No.: 14/993,676

(22) Filed: Jan. 12, 2016

Related U.S. Application Data
(60) Provisional application No. 62/285,001, filed on Oct. 16, 2015.

(51) Int. Cl. G06Q 30/02

(52) U.S. Cl. CPC G06Q 30/0269; G06Q 30/0277

(57) ABSTRACT

Content targeting and recommendations based on object usage is described. In one or more implementations, a digital medium environment is described in which sensors are included as part of objects, detect usage events that result from object usage, and produce sensor data indicative of the events. In this digital medium environment, a method of generating recommendations that are based on the object usage is described. For objects associated with a user, sensor data is obtained that describes usage events detected by the object sensors that are included as part of the objects. The obtained sensor data is analyzed to compute statistics that summarize usage of the objects. Based on the statistics, recommendations are made to the user, such as to suggest a good, a service, or information that is determined pertinent to the user based on the usage of the objects.

### RELATED APPLICATION

This application claims priority under 35 U.S.C. §119 to Provisional Application No. 62/285,001, titled “Content Targeting and Recommendations Based on Object Usage” and filed on Oct. 16, 2015, the entire disclosure of which is incorporated by reference herein.

### BACKGROUND

User profiles, which can be used to deliver targeted content to individuals based on online behavior of the individuals, have evolved since inception to describe a vast number of online behaviors. The continued evolution of these profiles also enables the online behaviors of individuals to be described with increasing detail. By way of example, such user profiles can be constructed from browsing and online purchasing histories of users to describe behaviors, such as websites users visit, a number of times websites are visited and when, where users click on websites, goods and services users purchase from websites, goods and services users add to shopping carts of websites but do not purchase, and so on. With these user profiles, marketers are able to match users to target marketing segments or apply machine-learning techniques to match users to look-alike marketing segments. In so doing, marketers can advertise to users in increasingly personalized manners.

However, conventionally configured user profiles fail to completely capture an individual's experience as a consumer. By way of example, conventionally configured user profiles are limited to describing individuals using information that can be gleaned from the online behaviors of the individuals. Advertising techniques that utilize conventionally configured user profiles are thus based on data that incompletely describes an individual's consumerism. Consequently, marketers are limited in the ability to provide an ideal consumer experience.

### SUMMARY

Content targeting and recommendations based on object usage is described. In one or more implementations, a digital medium environment is described in which sensors are included as part of objects, detect usage events that result from object usage, and produce sensor data indicative of the events. In this digital medium environment, a method of generating recommendations that are based on the object usage is described. For objects associated with a user, sensor data is obtained that describes usage events detected by object sensors included as part of the objects. The obtained sensor data is analyzed to compute statistics that summarize usage of the objects. For example, the computed statistics indicate an amount of time the objects are used.

Based on the statistics, recommendations are made to the user, such as to suggest a good, a service, or information that is determined pertinent to the user based on the usage of the objects. To do so, the recommendations are first generated for presentation to the user. This can involve configuring content for presentation that describes the suggested good, service, or information. After the recommendations are generated, the recommendations are communicated for receipt by the user, e.g., the recommendations are emailed to the user, added to a web page viewed by the user, presented on an electronic billboard, presented via one of the objects associated with the user, and so on.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of a digital medium environment in an example implementation that is operable to employ content targeting and recommendations based on object usage techniques described herein.

FIG. 2 is an illustration of the digital medium environment in another example implementation that employs content targeting and recommendations based on object usage techniques.

FIG. 3 depicts a system in the digital environment of FIGS. 1 and 2 for targeting content and making recommendations to users based on usage by the users of the objects with which the users are associated.

FIG. 4 depicts an example of a user interface that is generated to present a user with a recommendation that suggests a good, service, or information determined pertinent based on the usage by the user of objects with which the user is associated.

FIG. 5 is a flow diagram depicting a procedure in an example implementation in which sensor data is obtained for objects associated with a user that describes usage of the objects, and in which recommendations are generated for the user based on the usage.

FIG. 6 is a flow diagram depicting a procedure in an example implementation in which targeted content is configured for presentation to a user based on usage of objects associated with a user profile of the user as well as supplemental information that is determined related to the usage of the objects.

FIG. 7 illustrates an example system including various components of an example device that can be implemented as any type of computing device as described and/or utilized with reference to FIGS. 1-6 to implement embodiments of the techniques described herein.

### DETAILED DESCRIPTION

Overview

Conventional user profiles, which can be used to deliver targeted content to individuals, fail to completely capture an individual's experience as a consumer. Although conventional profiles describe a vast number of online behaviors of individuals and with ever-increasing amounts of detail, such profiles are nevertheless limited to description of individuals using information that can be gleaned from online behaviors. The conventional profiles do not describe purchases individuals make of goods and services at brick and mortar stores, or how individuals actually use the goods and services purchased. Consequently, advertising techniques that utilize conventionally configured user profiles are limited to incomplete descriptions of consumers' behavior, and may thus hinder marketers from providing an ideal consumer experience.

With the advent of the Internet of Things (IoT), however, data can be collected about an individual's behaviors well beyond that which simply describes the individual's online interactions. Implementation of the IoT involves configuring products (e.g., devices, food, clothes, sporting equipment, automobiles, and so on) with sensors so that data indicative of product usage is collected and offline purchasing behaviors are tracked. This allows IoT-based user profiles to be generated that provide a more robust representation of an individual's consumer behavior than conventional user profile generation techniques do.

Content targeting and recommendations based on object usage are described. In contrast to targeting content to users using conventionally configured user profiles, the techniques described herein enable customized targeted content and recommendations to be delivered to users using the IoT and generated using IoT-based profiles. By using information about users collected through the IoT and maintained as part of IoT-based profiles, marketers can target individuals based on how the individuals actually use products.

Consider an example in which a user has a fishing pole, reel, lure, global positioning system (GPS) receiver, boat, and mobile phone configured for the IoT. By “configured for the IoT” it is meant that these objects (e.g., fishing pole, reel, lure, GPS receiver, boat, and mobile phone) are configured with sensors that detect usage events that result from usage. The fishing pole, for instance, can be configured with one or more of a gyroscope, accelerometer, rangefinder, and so on, to detect usage events which result from usage of the fishing pole, e.g., that a cast is performed, waiting with fishing line out, reeling in the line, performing a recast, getting a bite, as well as a time and location of those events. The lure tied to the line of the fishing pole can also be configured to detect usage events—those that result from usage of the lure. Responsive to detection of the usage events, the sensors included as part of the objects produce sensor data describing those events. For example, in response to detection of a cast sensors of the fishing pole and the lure can produce sensor data that describes the cast, such as when it was performed (e.g., by associating a timestamp with the cast), how far the lure was cast, the weather when the cast was made, and so on.

The data describing the usage events is then provided for aggregation and analysis. By way of example, the data captured by the sensors of the fishing pole and the lure that describe the use of those objects can be uploaded to a hub device, such as the mobile phone or GPS receiver for aggregation. From there, the data captured by the sensors can be communicated to a service provider, or may be communicated directly to the service provider from the sensors. In any case, the sensor data that describes the usage of the objects is eventually analyzed to compute statistics that summarize usage of the objects.

For example, sensor data received for a most recent fishing excursion of a user may be analyzed to indicate that the user was not successful in catching any fish. The techniques described herein may also reference other data indicating that, in the location the user was fishing and at the time the user was fishing, a lure different from the one used would likely have resulted in catching fish (or would increase the likelihood of catching fish). Such data may be collected from other users who fished in the same area and at the same time whose fishing poles, lures, and so on provided information via the IoT, but who were successful in catching fish. Based on the determination that a different lure would likely have resulted in greater success, the techniques described herein can recommend the different lure to the unsuccessful user. For example, the techniques described herein can generate a notification that is delivered to the mobile phone of the user and indicates the different lure, that the different lure is determined likely to be more successful at the location where the user was fishing, how the user can purchase the different lure, and so forth.

Broadly speaking, the techniques described herein make recommendations suggesting goods, services, and information that is determined pertinent to a user based on analysis of usage data collected from the objects the user uses. Given data indicative of actual object usage, marketers can determine a product's actual lifespan (in contrast to an intended lifespan), determine when a user is reaching the end of the product's actual lifespan, and recommend new products to replace old products. Additionally, marketers can determine from the object usage data whether a user is likely to purchase goods or services that supplement the ones the user already uses, or whether the user is likely to benefit from goods, services, or information that supplement the products the user already uses. In this way, the techniques described herein target content and recommendations based on information that more fully represents an individual's behavior as a consumer than conventional techniques. Consequently, the techniques described herein can provide an improved consumer experience in comparison to traditional marketing techniques.

As used herein, the term “object” refers to a good that is usable by an individual and which can be configured or packaged with sensors to detect usage events that result from use and produce data indicative of the detected events. Examples of objects include devices, e.g., mobile phones, landline phones, tablet devices, desktop computing devices, televisions, set top boxes, stereo receivers, digital video disc (DVD) players, digital music players, GPS receivers, gaming consoles, gaming controllers, entertainment systems, navigation systems, cameras, device peripherals such as a mouse, keyboard, headphones, stylus, speakers, and so on. Such devices can be configured or packaged with sensors in a variety of ways. For example, the packaging of such devices can include sensors to detect whether the packaging has been opened, electronic sensors can be embedded as part of the devices to communicate with the devices about their usage (e.g., connectively coupled to a device bus, circuits, and so on of the devices), electronic sensors can be embedded as part of the devices to communicate with other devices about usage (e.g., using short or long range communication technologies), sensors can be attached to the devices using adhesives (e.g., the sensors can be included as part of stickers placed on the devices), and so forth.

Food items are other examples of objects, and can include perishable items (e.g., meats, poultry, game, vegetables, fruits, dairy, eggs, and so on), non-perishable items (e.g., canned vegetables, canned meats, canned soups, canned fruit, food items in jars, and so on), processed foods (e.g., pasta, bread, condiments, pre-packaged meals, desserts, chips, crackers, and so on), beverages (e.g., soda, coffee, tea, alcoholic beverages, sports drinks, and so on), baking goods (e.g., flour, sugar, oils, vinegars, spices, and so on), and so forth. Food items can also be configured or packaged with sensors in a variety of ways. For example, the packaging of food items can include sensors (e.g., meat that is packaged to sit on a Styrofoam tray and wrapped in plastic wrap can have a sensor included as part of a sticker placed on the plastic wrap—one capable of providing a variety of information about usage of the meat, such as whether a temperature of the meat has surpassed a threshold temperature for a threshold amount of time associated with spoilage, a number of days remaining until the meat should be thrown out; twist ties used to bundle vegetables can be configured with sensors; sensors can be attached to or embedded in boxes, bottles, jars, cans, and containers used to package food—to provide a variety of information about the food packaged therein such as an amount of the food remaining, a number of days until the food is spoiled, and so forth), sensors can also be affixed directly to food items (e.g., sensors included as part of stickers can be attached to pieces of fruit, vegetables, and so on), and so forth.

Appliances are other examples of objects and can include refrigerators; freezers; convection/conventional ovens; microwave ovens; dishwashers; washers and dryers; ranges and cooktops; small kitchen appliances (e.g., coffee makers, tea makers, espresso makers, blenders, juicers, mixers, toasters, toaster ovens, pots and pans, slow cookers, crock pots, roaster ovens, food processors, and so on); kitchen gadgets (e.g., utensils, serving utensils, cutlery, and so on); heating, cooling, and air quality appliances (e.g., heaters, fireplaces, fans, air conditioners, air purifiers, humidifiers, dehumidifiers, thermostats, and so on); vacuum cleaners and floor care appliances; and so forth. In a similar manner as devices, appliances can configured or packaged with sensors in a variety of ways to ascertain their usage. For example, the packaging of appliances can include sensors to detect whether the packaging has been opened, electronic sensors can be embedded as part of the appliances to communicate with appliance firmware about their usage (e.g., connectively coupled to a bus, circuits, and so on of the appliances), electronic sensors can be embedded as part of the appliance to communicate with other devices about appliance usage (e.g., using short or long range communication technologies), sensors can be attached to the appliances using adhesives (e.g., the sensors can be included as part of stickers placed on the appliances), and so forth.

Other examples of objects can include clothes (e.g., pants, shirts, shorts, outerwear, undergarments, shoes, boots, and so on), sporting equipment (e.g., bats, balls, pads, helmets, sticks, skates, clubs, equipment bags, hunting and fishing equipment, camping equipment, optics, and so on), vehicles (e.g., cars, bicycles, motorcycles, aviation vehicles (planes, helicopters, and so on), watercraft, all-terrain vehicles, and so on), toys (e.g., dolls, action figures, blocks, remote control vehicles, miniaturized vehicles, games, and so on), consumable/disposable products (e.g., cleaning products, diapers, hygiene products, toilet paper, paper towels, napkins, and so on), and so forth. With regard to configuring or packaging such other items with sensors, they may be configured or packaged in a variety of ways. For example, sensors may be woven into the fabric or material of which clothes are made, the sensors can be included as part of the packaging in which the clothes are sold or in which the clothes are stored, the sensors can be included as part of clothing tags, and so forth. The sensors with which clothing is configured or packaged can communicate with devices about usage of the clothing (e.g., using short or long range communication technologies). With regard to sporting equipment, it may include embedded sensors such as gyroscopes, accelerometers, and the like, to detect usage and movement of the sporting equipment, such as ball flight or a movement path of a bat or club. Sporting equipment may also include other embedded sensors as part of the sporting equipment to communicate with devices about usage of the sporting equipment (e.g., using short or long range communication technologies). Vehicles can include a great many sensors for each part of a vehicle that is to be monitored. For example, seats of a vehicle can include sensors to determine when a person is sitting in the vehicle seat, engine components can include sensors to determine how those components are performing (e.g., that communicate data each time the component is under operation to indicate information associated with the operation, that test some components for levels of fluid, pressure, and so on), sensors to determine vehicle location, sensors to detect weather conditions, sensors to detect heat conditions, sensors to detect a level of darkness or lightness, and so forth. With regard to toys, the packaging of toys can include sensors to detect whether the packaging has been opened, electronic sensors can be embedded as part of the toys to communicate with devices about toy usage (e.g., using short or long range communication technologies), sensors can be attached to the toys using adhesives (e.g., the sensors can be included as part of stickers placed on the devices), and so forth. Consumable/disposable products can be configured or packaged with sensors in a similar manner, for instance, the packaging of consumable/disposable products can include sensors to detect whether the packaging has been opened, a remaining amount of the consumable/disposable product, whether the consumable/disposable product has surpassed a threshold condition causing it to no longer be safe for use, and so forth. Furthermore, the sensors with which consumable/disposable products are packaged and configured can communicate with devices about usage (e.g., using short or long range communication technologies). It is to be appreciated that the examples of objects and how these objects can be configured and/or packaged with a variety of different sensors should not be seen to limit the objects that can be configured or packaged with sensors or how those objects can be configured or packaged with sensors to enable them to interact as part of the IoT. Indeed, a variety goods not specifically enumerated herein can be objects of the IoT without departing from the spirit and scope of the techniques described herein.

The term “sensor” refers to any of a variety of types of sensors that objects can be configured with to detect usage events indicative of object use and produce data indicative of the object usage. Examples of sensors are enumerated in more detail in the discussion of the example environment. The term “usage event” refers to a change in the environment that results from use of an object and that is detectable by the sensors with which objects are configured. As mentioned above, an example usage event for a fishing pole is a cast. Usage events differ depending on an object as different objects are used in different ways, and different events are indicative of the objects being used.

As used herein, the term “sensor data” refers to the data produced by the sensors of an object that describes the usage events detected for the object. As used herein, “statistics that summarize usage” of objects refer to calculations that can be derived from multiple pieces of the sensor data to describe the usage of an object by a user, e.g., an amount an object is used, which can include a number of hours used, a number of times used, and so on. Other example statistics that summarize usage of objects are enumerated herein below.

The term “recommendation” refers to content that is configured to suggest at least one of a good, a service, or information to a user. The suggested “good” refers to a physical product that is available for purchase. The suggested “service” refers to a support product that can be provided by another entity to aid a user in accomplishing some task. The suggested “information” refers to content (e.g., text, pictures, and so on) that conveys data such as a message, counsel, instructions, education, and so on, to a user.

As used herein, “a digital medium environment” refers to the computing devices, the sensor-configured objects, the connections among the computing devices and sensor-configured objects, and the interfaces discussed in the example environment below and that make resources provided by service providers available to users.

In the following discussion, an example environment is first described that may employ the techniques described herein. Example implementation details and procedures are then described which may be performed in the example environment as well as other environments. Consequently, performance of the example procedures is not limited to the example environment and the example environment is not limited to performance of the example procedures.

Example Environment

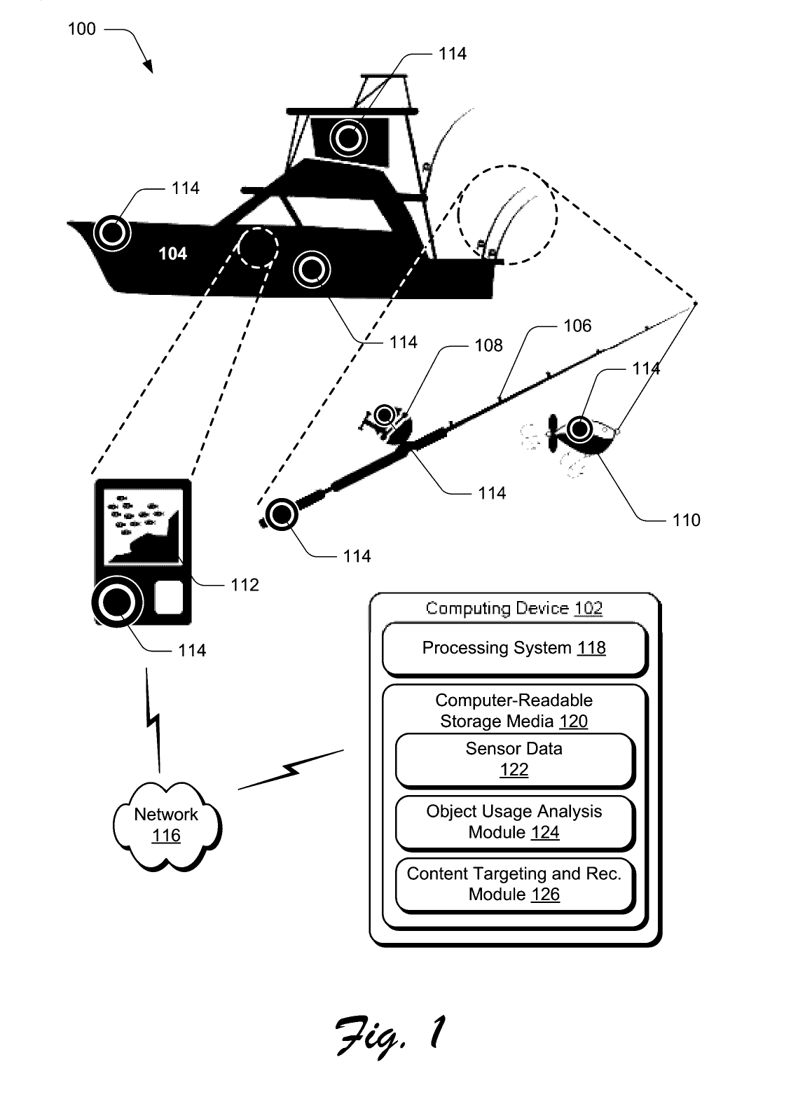

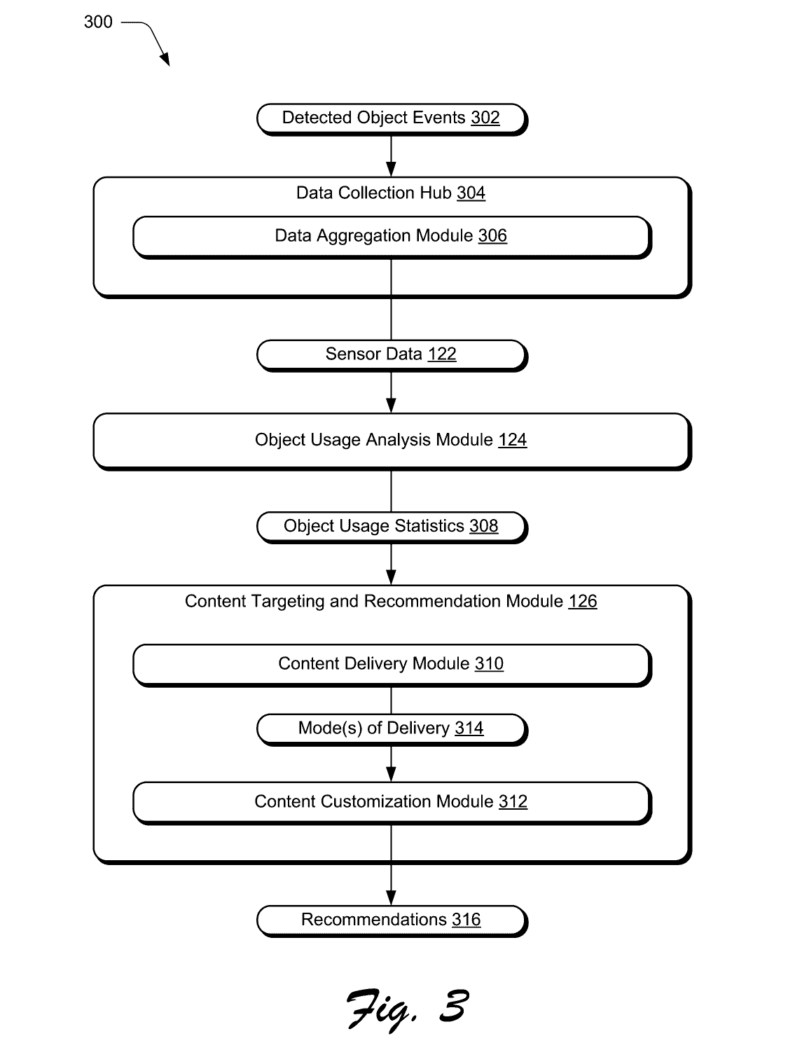

FIG. 1 is an illustration of a digital medium environment 100 in an example implementation that is operable to employ content targeting and recommendations based on object usage techniques described herein. The illustrated environment 100 includes a computing device 102, which may be configured in a variety of ways. The illustrated environment 100 also includes objects associated with a user that are part of the digital medium environment 100 through the inclusion of sensors that detect events indicative of object usage and produce data describing detected events. This data is then used to generate recommendations for the user as further described in relation to FIG. 3.

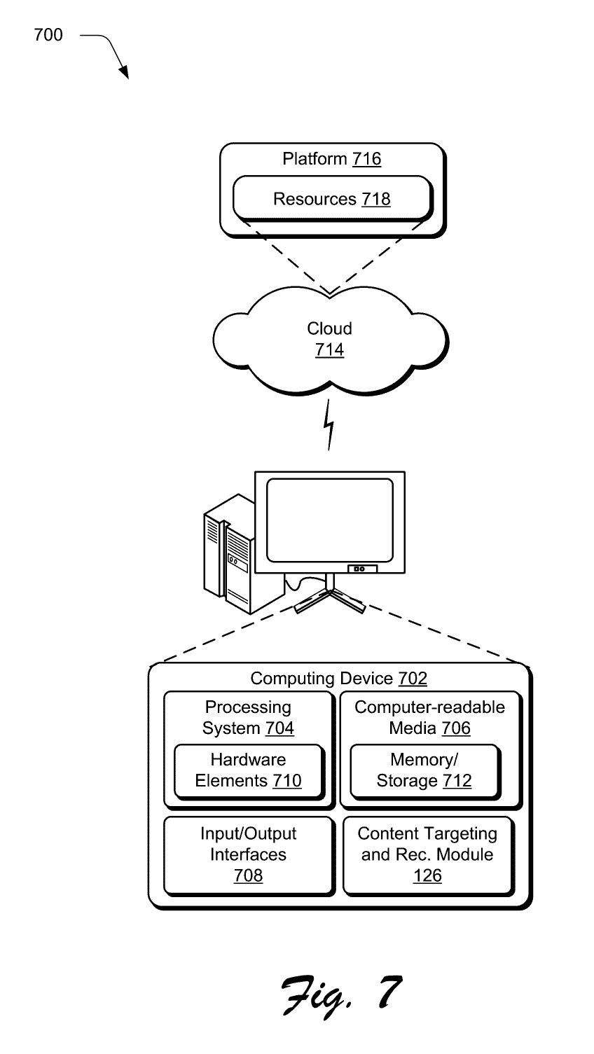

The computing device 102, for instance, may be configured as a desktop computer, a server computer, a laptop computer, a mobile device (e.g., assuming a handheld configuration such as a tablet or mobile phone), and so forth. Thus, the computing device 102 may range from full resource devices with substantial memory and processor resources (e.g., service-provider computers, personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business to perform operations “over the cloud” as further described in relation to FIG. 7.

The computing device 102 is illustrated as included with a variety of objects within the digital medium environment 100 as part of the Internet-of-Things (IoT). The IoT describes a digital medium environment in which a plurality of objects are configured with sensors to detect events that occur as a result of using the objects and in which the sensors have connectivity (e.g., network functionality such as wired or wireless communication abilities) to communicate data for receipt by a user or other devices, such as a hub device. This allows communication of information to support aggregating and analyzing object usage data, thereby creating opportunities for integration between a physical environment in which objects are used and techniques to track and analyze object usage. This is used to support functionality to improve efficiency, accuracy, and aide marketers and manufacturers as well as users of the objects.

Illustrated examples of objects included as part of this digital medium environment 100 include sensor-configured goods. For the convenience of discussion, the sensor-configured goods of the digital medium environment 100 relate to a single example scenario—an example fishing scenario—and include boat 104, fishing rod 106, fishing reel 108, lure 110, and GPS receiver 112. The example fishing scenario is but one scenario in which the techniques described herein can be used, however, and use of the example fishing scenario should not be seen to limit application of the invention. Indeed, the techniques described herein are capable of being applied to a variety of other scenarios in which object usage data can be provided by sensors of objects to describe object use. Regardless of the particular objects used or the scenario in which used, the objects are configured with sensors 114 to detect events that occur as a result of use and to ascertain information associated with the use.

The sensors 114 represent any of a variety of sensors that the objects may be configured with to detect events indicative of object use. By way of example, the sensors 114 can correspond to acoustic, sound, and vibration sensors; automotive and transportation sensors; chemical sensors; electric current, electric potential, magnetic, and radio sensors; flow and fluid velocity sensors; ionizing radiation and subatomic particle sensors; navigation instrument sensors; position, angle, displacement, distance, speed, and acceleration sensors; optical, light, imaging, and photon sensors; pressure sensors; force, density, and level sensors; thermal, heat, and temperature sensors; proximity and presence sensors; and so on. In other words, the sensors 114 with which objects of the IoT are configured enable events indicative of object use to be detected.

With regard to the objects in the example fishing scenario, for instance, the sensors 114 can detect events indicative of use of the fishing rod 106 and the lure 110, such as casting the lure 110, waiting with the lure 110 in the water, reeling in the lure 110, recasting, getting a fish to bite, actually catching a fish, and so on. Further, the sensors 114 of the GPS receiver 112 may enable a determination of its location at a given time and the sensors 114 of the boat 104 may detect events indicative of its navigation, weather conditions, operation conditions of the boat 104's engine, and so forth.

Once the sensors 114 detect an event indicative of an object's use, the sensors 114 produce data describing the detected event. Some of the sensors 114 or the objects in which the sensors 114 are included may be capable of caching that data and performing computations with the data. However, some of the sensors 114 and the objects in which the sensors 114 are included may not be capable of caching much, if any, of the data produced or performing computations with the data.

Consider the GPS receiver 112, for example. The GPS receiver 112 may be capable of caching the usage data produced and performing computations with the usage data. In contrast, the fishing rod 106, the lure 110, and the sensors 114 of those objects may not be capable of caching the usage data produced or performing computations with the usage data. Rather, the sensors 114 of the fishing rod 106 and the lure 110 may simply provide the usage data to another entity for aggregation and analysis.

For instance, the sensors 114 of the fishing rod 106 and the lure 110 may communicate the data to the GPS receiver 112. Said another way, the sensors 114 communicate the sensor data to a device capable of aggregating the usage data, and in some cases analyzing the usage data, e.g., the GPS receiver 112, a mobile phone (not shown), instrumentation of the boat (not shown), and so on. In this way, the device to which the sensor data is communicated and where it is aggregated can act as a hub device. As used herein, a “hub device” refers to a device that is capable of collecting sensor data from one or more sensors deployed in one or more respective objects (which may or may not include the hub device) to detect usage events that occur as a result of using the objects. In the example fishing scenario, the GPS receiver 112 is capable of serving as a hub device for the sensors 114 of the boat 104, the fishing rod 106, the fishing reel 108, and the lure 110.

From a hub device, the sensor data can be communicated over a network 116, such as the Internet, to provide a “cloud-based” computing environment, in which the computing device 102 provides services of one or more service providers. In one or more implementations, at least some of the sensors 114 may be configured to communicate the sensor data over the network 116 directly to the computing device 102 without first routing the sensor data through a hub device.

Service providers are generally configured to make various resources available over the network 116 to users. In some scenarios, users sign up for accounts that are employed to access corresponding resources from a provider. The provider authenticates credentials of a user (e.g., username and password) before granting access to an account and corresponding resources. Other resources are made freely available, (e.g., without authentication or account-based access). The resources can include any suitable combination of services and/or content typically made available over a network by one or more providers. Some examples of services include, but are not limited to, communication services (e.g., email, instant messaging, voice over Internet Protocol (VoIP), and the like), online stores (e.g., Amazon®, Best Buy®, Walmart®, Costco®, and so on) via which users can select items such as goods or services for purchase, information providers (e.g., news services, blogging services, and the like), and so forth.

Broadly speaking, the computing device 102 represents functionality of a service provider to obtain sensor data that describes object usage and provide a user with recommendations based on the object usage. The computing device 102 has a processing system 118 that includes one or more processing devices (e.g., processors) and one or more computer-readable storage media 120. The illustrated digital medium environment 100 also includes sensor data 122, an object usage analysis module 124, and a content targeting and recommendation module 126 (“content targeting and rec. module 126”) embodied on the computer-readable storage media 120 and operable via the processing system 118 to implement corresponding functionality described herein.

The sensor data 122 represents data produced by the sensors 114 that describes usage events which occur as a result of using the objects configured with the sensors 114. The sensor data 122 for a particular object may be configured according to a data structure that is predefined according to how the particular object is used. For example, the sensor data 122 for a particular object can include data fields that are different than those used in conjunction with another object, and can be chosen to describe the events which occur as a result of using the particular object. For instance, the sensor data 122 for a particular object may have a field that can be populated with a value to indicate a name of a usage event, a field to indicate an associated time, fields for other values associated with the usage event, and so on. With respect to the fishing rod 106, for instance, the sensor data 122 may include an ‘Event Name’ field (that can be populated with values such as “cast detected”, “bite detected”, “reel-in detected”, etc. that are indicative of a detected event), a time field that can be populated with a timestamp indicative of a time the usage event is detected, and so forth. Continuing with the example fishing scenario, the sensor data 122 associated with the GPS receiver may include fields for GPS location and time. Despite differences in the sensor data 122 produced for different objects, the sensor data 122 is capable of describing use of the objects of the IoT.

Additionally, the sensor data 122 can be maintained on a per user basis, such that the sensor data 122 produced for objects associated with a given user is maintained in conjunction with a user profile of the given user. In a similar manner, the sensor data 122 produced for objects associated with another user is maintained in conjunction with a user profile of the other user.

Still further, the sensor data 122 may be received at the computing device 102 in an aggregated form. By way of example, a hub device may collect sensor data indicative of usage events as the usage events are detected and directly from the sensors included in the objects used. Such a hub device may aggregate the data communicated thereto by the sensors 114 over a period of time and then communicate aggregated sensor data to the computing device 102 for processing. This hub device may do so at predetermined intervals, responsive to receipt of data indicating to initiate communication of the aggregated data (e.g., an event indicating the end of a usage scenario, such as the end of a fishing trip), and so on.

Alternately or in addition, the sensor data 122 may be aggregated by the sensors 114 and then communicated from the sensors 114 in aggregated form to the computing device 102. Still further, the sensor data 122 may be communicated directly from the sensors 114 to the computing device 102 where it is aggregated and processed. The sensor data 122 may be configured in a variety of different formats and received by the computing device 102 in a variety of different ways to enable the techniques described herein without departing from the spirit or the scope of those techniques.

The object usage analysis module 124 and the content targeting and rec. module 126 represent functionality to implement techniques for content targeting and recommendations based on object usage as described herein. The object usage analysis module 124 represents functionality to process the sensor data 122 to derive information that indicates how a user uses objects in the IoT. By way of example, the object usage analysis module 124 processes the sensor data 122 to compute statistics that describe the usage of objects by a user. The object usage analysis module 124 is capable of computing an amount the objects associated with a user are used, for example. Regarding the fishing rod 106, the object usage analysis module 124 can compute a number of times the fishing rod 106 has been cast, a number of hours it has been in use for fishing, and so on. The object usage analysis module 124 can compute a variety of statistics indicating use of the objects without departing from the spirit or scope of the techniques described herein. Usage statistics and other information generated by the object usage analysis module 124 to describe a user's use of objects can serve as a basis for a variety of services, including, but not limited to, a basis for suggesting goods, services, and additional information to a user.

The content targeting and rec. module 126 is configured to make recommendations to a user based on how the user uses the objects with which the user is associated. To do so, the content targeting and rec. module 126 determines goods, services, and information that are pertinent to the user based on how the user uses objects. Given the statistics indicative of object use computed by the object usage analysis module 124, for example, the content targeting and rec. module 126 is capable of determining which goods, services, and information are pertinent to a user. Once the content targeting and rec. module 126 determines goods, services, and information that is pertinent to a user, it generates one or more recommendations that suggest the determined goods, services, and information.

To generate the recommendations, the content targeting and rec. module 126 configures content (e.g., email, a web page, and so on) for presentation to a user to include portions of content (e.g., images, text, videos, hyperlinks, and so forth) for conveying the recommendations to the user. The content targeting and rec. module 126 is also capable of determining an interface via which to present the recommendation to a user and generate the content according to the determined interface. By way of example, the content targeting and rec. module 126 may determine that the recommendation is likely to be most useful to the user if it is seen right away. As such, the content targeting and rec. module 126 can choose an interface for presenting the recommendation that the user is likely to interact with frequently or enables the user to be notified of delivery, such as a texting interface of a mobile phone. Accordingly, the content targeting and rec. module 126 configures the recommendation based on the interface chosen for its delivery. Once generated, the content targeting and rec. module 126 communicates the recommendations for receipt by the user.

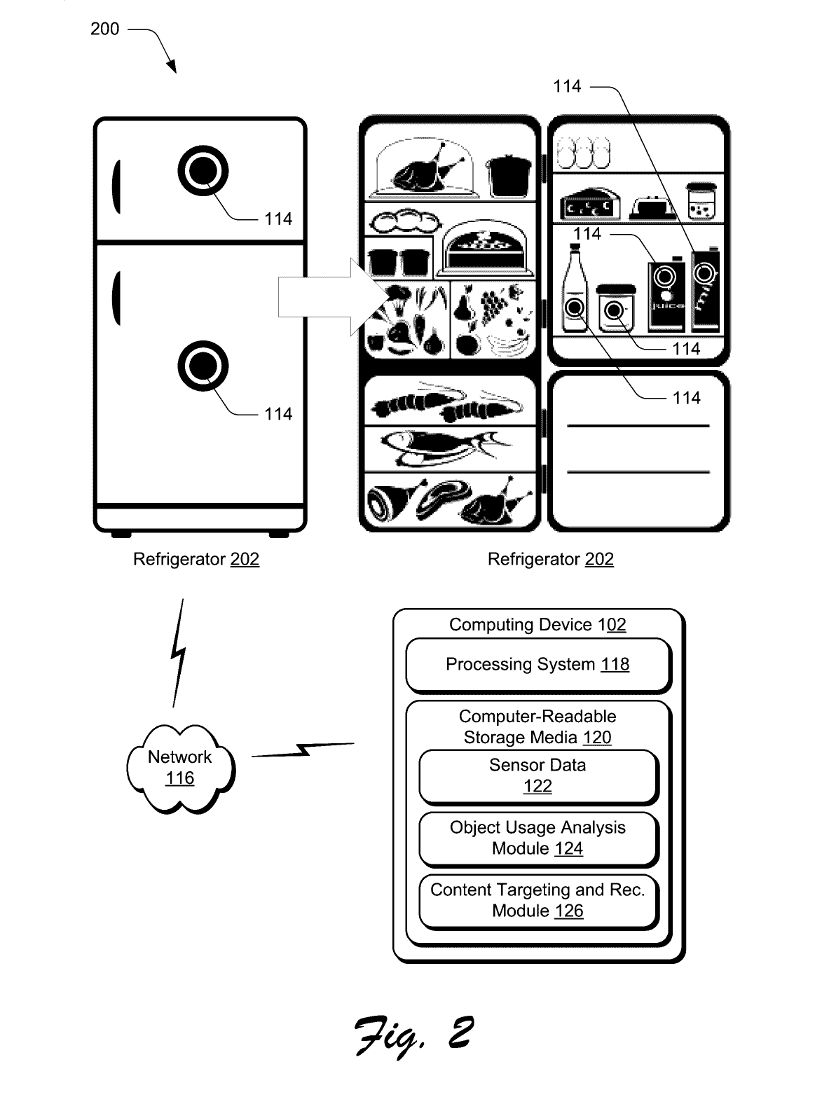

FIG. 2 is an illustration of the digital medium environment in another example implementation at 200 that employs content targeting and recommendations based on object usage techniques. In particular, the example illustrated at 200 illustrates another example scenario—a home appliance scenario—that includes refrigerator 202, which is illustrated as being closed at left, and open at right exposing food stored in the refrigerator. FIG. 2 also depicts that the refrigerator 202 includes the sensors 114 and that the food stored in the refrigerators 114 includes or is also packaged with the sensors 114. The refrigerator 202 can be configured with sensors to detect a variety of information about object usage, such as a temperature (or temperature distribution) of a refrigeration portion of the refrigerator 202, a temperature (or temperature distribution) of a freezer portion of the refrigerator 202, weight of food items in the refrigerator, whether and which items are taken out of the refrigerator 202 and put in the refrigerator, smells that result from food spoilage, and so forth. The food in the refrigerator 202 can also be configured or packaged with the sensors 114, as described in more detail above, to detect information about the food, e.g., whether the food is still edible, a remaining time until the food is no longer edible, a remaining amount of the food, and so forth.

As with the example fishing scenario, the sensors 114 in the example home appliance scenario detect events indicative of an object's use (e.g., the refrigerator 202 or the food stored therein), produce the sensor data 122 indicative of the detected event (e.g., a food item was removed from the refrigerator 202), and communicate the sensor data over the network 116 to the computing device 102. The object usage analysis module 124 and the content targeting and rec. module 126 can then process the sensor data 122 from the sensors 114 of the refrigerator 202 to generate targeted content and recommendations to a user of the refrigerator 202, such as recipes that use the food stored in the refrigerator 202, a grocery list, a list of food that is in the refrigerator 202 that should be thrown away, and so on.

In one or more implementations, the object usage analysis module 124 and the content targeting and rec. module 126 are implementable as software modules, hardware devices, or using a combination of software, hardware, firmware, fixed logic circuitry, etc. Further, the object usage analysis module 124 and the content targeting and rec. module 126 can be implementable as standalone components of the computing device 102 as illustrated. In addition or alternatively, the object usage analysis module 124 and the content targeting and rec. module 126 can be configured as components of a web service, an application, an operating system of the computing device 102, a plug-in module, or other device application as further described in relation to FIG. 7.

Having considered an example environment, consider now a discussion of some example details of the techniques for content targeting and recommendations based on object usage in accordance with one or more implementations.

Content Targeting and Recommendations Based on Object Usage

This section describes some example details of techniques for content targeting and recommendations based on object usage in accordance with one or more implementations. FIG. 3 depicts a system in the digital environment of FIGS. 1 and 2 for targeting content and making recommendations to users based on usage of objects with which the users are associated.

The example system 300 includes detected object events 302, which are provided as input to data collection hub 304. The detected object events 302 represent data describing events that result from use of objects associated with a user and that are detected by the sensors 114 included in the objects. Objects may be associated with a user in a variety of ways. By way of example, users may have profiles with one or more service providers that enable the object usage by the users to be tracked and analyzed. To initiate usage tracking (e.g., so that services based on the usage can be provided), users may be required to register their objects for association with respective user profiles.

A user may, for instance, use a mobile phone to scan a bar- or QR-code of a product recently purchased, and an application of the mobile phone may associate the product with a user profile of the user based on the scanned code. An object may be associated with a user in a variety of additional ways without departing from the spirit or scope of the techniques described herein. Associating objects with a user in such manners allows offline purchases to be tracked.

In contrast to conventional techniques that are limited to monitoring online purchasing activity of a user, the techniques herein monitor both online and offline purchases, e.g., those made in brick and mortar stores. By doing so, the techniques described herein enable a user profile to be generated for a user that is more robust than conventional techniques. By “more robust” it is meant that the user profile reflects a user's activity as a consumer (e.g., purchases, use of goods and services, non-use of goods and services, replacement purchases, supplemental purchases, and so on) to a greater degree than conventionally generated user profiles. Consequently, the techniques herein enable content to be targeted and recommendations made that are more useful to a user or are more effective for obtaining the results desired by a marketer (e.g., the user purchasing a good or service advertised) than conventional techniques. This is because such targeted content and recommendations are based on a more complete description of the user's behavior as a consumer than conventional techniques.

Regardless of how an object is associated with a user, once associated, the sensors 114 of the object provide the detected object events 302 so that use of the object can be tracked and analyzed. In one or more implementations, the sensors 114 of the objects provide the detected object events 302 to the data collection hub 304. The data collection hub 304 includes data aggregation module 306, which represents functionality of the data collection hub 304 to aggregate the data collected from the sensors 114. The data collection hub 304 is configured to collect data from the sensors 114 of multiple objects associated with a user. The data collection hub 304 may correspond to a variety of devices associated with a user, such as a mobile phone of the user.

The data aggregation module 306 of the data collection hub 304 aggregates the detected object events 302 provided by the sensors 114. The data aggregation module 306 may aggregate the detected object events 302 for communication over the network 116 to the computing device 102. Aggregation of the detected object events 302 can involve caching the detected object events 302 over a period of time, which may be a predetermined interval of time (e.g., a minute, an hour, multiple hours, days, and so on), a period of time corresponding to a particular usage scenario (e.g., in the continuing example, while the user is fishing, the end of which can be determined with the detection of some event like the fishing rod 106 being placed in a case, placed in a cabin of the boat 104, and so on), and so forth. Aggregation of the detected object events 302 can also involve addressing discrepancies in the data, such as removing errors in the data, duplicates in the data, and so on. In one or more implementations, aggregation of the detected object events 302 involves formatting the detected object events 302 in a different format from the one received at the data collection hub 304, such as a format suitable for communication to the computing device 102, a format that allows the computing device 102 to more efficiently perform analyses of the data, and so on. The sensor data 122 represents the detected object events 302 as communicated from the data collection hub 304 over the network 116 and to the computing device 102. In other words, the sensor data 122 may correspond to aggregated and formatted detected object events 302.

With reference to the particular example fishing scenario of FIG. 1, the GPS receiver 112 may correspond to the data collection hub 304 of FIG. 3. In this scenario, the GPS receiver 112 may thus collect data from the sensors 114 of the other objects in the example fishing scenario. In other words, the GPS receiver 112 may collect the detected object events 302 from the sensors 114 of the boat 104, the fishing rod 106, the fishing reel 108, and the lure 110. Accordingly, the sensors 114 of these objects may provide the detected object events 302 to the data collection hub 304.

In some implementations, there may be no intermediary, such as the data collection hub 304, between the sensors 114 and the computing device 102. Instead, the detected object events 302 may be aggregated by respective sensors and formatted into the sensor data 122 for communication directly to the computing device 102 for processing. In addition or alternately, the detected object events 302 may simply be communicated as the sensor data 122 over the network 116 to the computing device 102 as the events are detected, e.g., without being aggregated by the sensors 114 or a hub device. In this instance, the computing device 102 is configured to aggregate the sensor data 122 so that it can then be processed for content targeting and recommendations. Regardless of whether the computing device 102 obtains the sensor data 122 in an already-aggregated format (e.g., from the data collection hub 304) or in a not-yet-aggregated format (e.g., directly from the sensors 114 as the usage events are detected), the computing device 102 is capable of maintaining the sensor data 122 so that it is associated with a respective user, e.g., by maintaining the sensor data 122 as part of a user profile of the user.

Once obtained, the sensor data 122 can be analyzed to compute statistics indicative of a user's use of the objects for which the sensor data 122 is obtained. These statistics are represented in FIG. 3 by object usage statistics 308. The object usage analysis module 124 represents functionality to compute the object usage statistics 308 using the sensor data 122 as input. The object usage statistics 308 represent a variety of different statistics indicative of object use that can be computed by analyzing the sensor data 122. For example, the object usage statistics 308 can include statistics indicative of object use by a particular user such as an amount an object is used by the user, a frequency the user uses the object, a propensity of the user to use one or more other objects with the object (e.g., an amount of time or a frequency the user uses any other objects with the object), statistics regarding where an object is used (e.g., a heat map as to where an object is used most and least, an ordered list of places where the object is used, and so on), statistics regarding when an object is used (e.g., time of day, season, occurrence of events that result in use of the object, and so on), an amount of time between uses, an amount of time between purchase of the object and first use, where the user stores the object, other objects that are stored with the object, and so forth.

The object usage analysis module 124 is also configured to compute the object usage statistics 308 using the sensor data 122 that is obtained from objects associated with multiple different users. Thus, the object usage statistics 308 computed using the sensor data 122 obtained from the objects of multiple users can include statistics such as an observed lifespan of an object (e.g., as opposed to a lifespan ascertained by an object manufacturer), observed object lifespan by location (e.g., how long an object is usable or commonly used in different geographic locations), average lifespan (e.g., mean, median, mode, and so on), other objects that users use with the object, other objects that users use with the object by location, uses of the object that contribute to decreased object lifespan, uses of the object that contribute to prolonged object lifespan, locations where users generally do or do not use objects, times that users generally do or do not use objects, times that users generally do or do not use objects by location, a propensity of an object purchaser to use the object, a propensity of an object user to have been given the object, and so forth. Although a variety of statistics indicative of object use by one user and multiple users are enumerated herein, the object usage analysis module 124 may be configured to compute a variety of other statistics that describe how users use objects of the IoT in the spirit and scope of the techniques described herein.

The object usage statistics 308 are provided to the content targeting and rec. module 126. Broadly speaking, the content targeting and rec. module 126 represents functionality to generate targeted content and recommendations for users based on the objects the users purchase (both online and offline) and the use of those objects by the users. The content targeting and rec. module 126 also represents functionality to deliver generated recommendations to users. As part of the generating and the delivering, the content targeting and rec. module 126 processes the object usage statistics 308. To generate and deliver the targeted content and recommendations, the content targeting and rec. module 126 employs content delivery module 310 and content customization module 312. The content delivery module 310 represents functionality of the content targeting and rec. module 126 to determine an interface for delivering targeted content and recommendations, and the content customization module 312 represents functionality of the content targeting and rec. module 126 to configure the targeted content or recommendations for delivery to a user.

With regard to the content delivery module 310, it determines interfaces via which targeted content and recommendations are to be presented to a user. To do so, the content delivery module 310 is capable of ascertaining interfaces that are available to present the user with targeted content and recommendations. For example, if a user has a mobile phone, the content delivery module 310 is capable of determining whether the mobile phone includes functionality to receive texts, instant messages, calls, emails, access the Internet, and so on. By determining that the mobile phone of a user includes this functionality, the content delivery module 310 “knows” that the user is capable of being presented with targeted content and recommendations via text, instant message, phone call, email, a link to a web page accessible via the Internet, and so on. In other words, the interfaces that correspond to such functionality are available for presenting the user with targeted content and recommendations. The content delivery module 310 can thus select from those interfaces when determining which interfaces are to be used to present the user with generated targeted content and recommendations.

When determining which interface to use for the presentation of targeted content and recommendations, the content delivery module 310 can also consider other factors. For example, the content delivery module 310 can consider the location of a user. Using the user's location, the content delivery module 310 can determine whether the user is close to any interfaces that are configurable for the purpose of presenting targeted content and recommendations, such as electronic billboards.

As used herein, the term “electronic billboard” means an interface capable of being changed by a computing device to display different content at different times. By way of example, an electronic billboard having a size of a conventionally configured billboard can be located near a highway and changed daily (or more often) to display different content. Such an electronic billboard may be changed to display some particular content during rush hour and then different content when it is not rush hour. Further, such an electronic billboard can be used to display targeted content and recommendations for one individual who is driving past, such as when the electronic billboard is passed by very few cars and the one individual is determined to likely to see the electronic billboard. Electronic billboards are not limited to locations alongside roads, however. A subway window may also act as an electronic billboard configured to display different content at different times. In this way, a user who sits facing the subway window can be shown targeted content and recommendations during his or her subway trip that is determined pertinent to him or her. Regardless of the type of configurable interface, the content delivery module 310 can consider the location of a user to determine interfaces for presenting targeted content and recommendations.

Electronic billboards and other configurable interfaces, such as the above-discussed subway window, represent scenarios in which objects of the IoT interact with other objects connected to the IoT to communicate targeted content and recommendations. For example, an object associated with a user can communicate with a display that is not owned by the user, e.g., such as a display in a department store, the electronic billboard, the display-configured subway window, and so on. In this example, the display that is not owned by the user can then, when the user is in close proximity to the display, display targeted content and recommendations to the user, such as to recommend an item in a store that is on sale that the user is determined likely to purchase, determined likely to benefit from, and so on.

Such display scenarios can occur when the objects associated with a user have previously communicated the sensor data 122 for processing by the object usage analysis module 124 and the content targeting and rec. module 126, and a mobile phone of the user has been registered with a service of the IoT that gives users perks for object usage and purchase. In such display scenarios a display, such as an electronic billboard or subway window, is communicatively connected to the service of the IoT that gives users perks as well as to the object usage analysis module 124 and the content targeting and rec. module 126. When the user is proximate this display (e.g., with a threshold distance), the display may obtain an identification of the user from the mobile phone, e.g., an identifier of the user's profile. Using the identifier, the display communicates with the object usage analysis module 124 and the content targeting and rec. module 126 to determine targeted content and recommendations to deliver to the user via the display. The recommendations delivered via the display can thus be based not only on the user's usage of objects of the IoT, as indicated by the object usage statistics 308, but the recommendations delivered by such a display can also be based on a context of the display. By way of example, if the display is located in a shoe store or department, the display can recommend shoes to the user.

Returning to the discussion of the content delivery module 310, it can also consider the objects associated with a user when determining an interface to use for presenting the user with content. An object usage scenario may also be considered by the content delivery module 310 when determining an interface. With regard to the example fishing scenario, the content delivery module 310 may know that the user is associated with the boat 104, the fishing rod 106, the fishing reel 108, the lure 110, and the GPS receiver 112, as well as with instrumentation of the boat 104 and a mobile phone. The content delivery module 310 may also know that some of these objects are capable, in at least some manner, of presenting information to the user. The instrumentation of the boat 104, the GPS receiver 112, and the mobile phone may be capable of displaying rich HTML-configured content, for example. The fishing rod 106 and the fishing reel 108 may be configured with displays capable of displaying a line of text (or without displays, but with light emitting diodes (LEDs) to convey limited information). And the lure may not be configured to present information. Thus, the content delivery module 310 can consider the interfaces of the instrumentation of the boat 104, the GPS receiver 112, the fishing rod 106, the fishing reel 108, and the mobile phone. When the sensor data 122 indicates that the user is currently fishing, however, the content delivery module 310 may eliminate some of those interfaces from consideration for a variety of reasons. For example, the content delivery module 310 may determine that the mobile phone is likely to be in an area that does not get cellular service because the user is fishing, and thus not to present targeted content or recommendations to the user via the mobile phone.

Further, the content delivery module 310 may also consider the targeted content to be delivered or the recommendations made when determining which of the interfaces associated with a user are available, and which are best suited to present the targeted content and recommendations. That is to say, the content delivery module 310 is capable of considering a variety of different factors when determining which interface accessible to a user is to be used to present the user with targeted content and recommendations. Although a variety of factors have been described herein, the content delivery module 310 is capable of considering still other factors to determine which interfaces to use to present targeted content and recommendations to a user in the spirit and the scope of the techniques described herein.

FIG. 3 also includes mode(s) of delivery 314, which represent the one or more interfaces chosen by the content delivery module 310 for presenting the targeted content or recommendations to the user. The mode(s) of delivery 314 can be provided to the content customization module 312 to enable it to generate targeted content and recommendations that are presentable via the determined interfaces. For example, when the mode(s) of delivery 314 indicate that the targeted content or recommendations are to be presented via text message, the content customization module 312 generates the targeted content or recommendations as text messages.

The content customization module 312 represents functionality to generate targeted content and recommendations for presentation to a user. The targeted content generated by the content customization module 312 may correspond to advertising content for goods or services determined pertinent to users based on how the users use objects. The recommendations generated by the content customization module 312 may suggest goods, services, or information determined pertinent to users based on how the users use objects. Recommendations 316 represent such targeted content and recommendations, and are provided by the content customization module 312 for receipt by a user.

In order to provide the recommendations 316, the content customization module 312 makes a determination regarding what goods, services, and information are pertinent to a user. The content customization module 312 determines pertinent goods, services, and information based on a user's usage of the objects with which the user is associated. In other words, the content customization module 312 determines pertinent goods, services, and information based, at least in part, on the object usage statistics 308. Not only is the content customization module 312 capable of determining pertinent goods, services, and information based on the object usage statistics 308, but it also does so based on supplemental information, such as information that originates from sources other than the objects associated with the user.

The object usage statistics 308 may be used not only to determine what goods, services, and information are pertinent to a user but also to determine when to make recommendations to the user. By way of example, the object usage statistics 308 may indicate that an amount a user has used the fishing rod 106 is nearing an observed lifespan of the fishing rod 106. When an amount the user has used an object surpasses a predetermined threshold, the techniques described herein can initiate generation of recommendations for the user that suggest replacement objects.

Continuing with the example in which the fishing rod 106 is determined be nearing its observed lifespan (e.g., based on a comparison of the amount of use to a predetermined threshold, such as 95% of the observed lifespan), the content customization module 312 can determine to initiate communication of recommendations for replacement fishing rods to the user. The goods, services, and information suggested are based on the use described by the object usage statistics 308. The recommendations 316 for replacement fishing rods, for example, can be based on how the user uses the fishing rod 106. Based on the object usage statistics 308, for instance, the user is determined to use the fishing rod 106 to catch fish that are larger than what the fishing rod 106 is designed for so a recommendation can be made for a replacement rod designed to catch larger fish, the user is determined to use the fishing rod 106 to catch fish that are smaller than what the fishing rod 106 is designed for so a recommendation can be made for a replacement rod designed to catch smaller fish, the user is determined to use the fishing rod 106 to catch fish that are commensurate in size to the fish the fishing rod 106 is designed for so a recommendation can simply be made for a newer version or a same version of the fishing rod 106, and so on.

The supplemental information used by the content customization module 312 can be obtained from a variety of different sources and relate to a variety of aspects associated with object usage. By way of example, such supplemental information can relate to a time associated with detection of usage events, location information that indicates where an object was used and can be obtained from a mobile phone (or GPS receiver, or other device capable of providing location information) carried by the user or near the user while the object is used. The supplemental information can also include weather data provided from a weather service based on the location of the user, usage data of other users who are using objects in a similar usage scenario as the user (e.g., using similar objects, using objects at a nearby location, and so on), information contained in a user profile of the user (e.g., historical purchasing information, demographic information, preference information and so on), information of users who are determined similar to the user based on similar information in user profiles, and so forth.

In one example of supplemental information use, historical purchasing information contained in a user profile is used. The historical purchasing information may indicate that a user typically purchases products that are considered “top-of-the-line” (e.g., because the products are the most expensive, the brand of the product is associated with being top of the line, the products are advertised as being top of the line, and so on) regardless of whether other products are determined to perform better. Based on this information, the content customization module 312 can generate recommendations for the user to suggest goods, services, and information that are also considered top of the line. In contrast, the historical purchasing information of another user may indicate that the other user typically purchases products that have a good value, e.g., more desired features or better characteristics per unit of price than other products. Based on this information, the content customization module 312 can generate recommendations for the other user for goods, services, and information that are considered to have good value.

The supplemental information used by the content customization module 312 can also include marketing information. The content targeting and rec. module 126 represents functionality to obtain marketing information from marketers. Marketing information can include marketing segments (e.g., outdoor enthusiast, team sports enthusiast, luxury good enthusiast, technology enthusiast, and so on). It can also indicate how to associate users with various segments, such as based on the object usage statistics, the objects associated with a user, purchasing history, and so on.

Consider an example in which the marketing information indicates that a user who uses outdoor goods or services, or accesses outdoor information at least three hours a week is associated with the outdoor enthusiast marketing segment. The content targeting and rec. module 126 can analyze the object usage statistics 308 and user profile of a user to determine whether to associate the user with the outdoor enthusiast marketing segment, e.g., if the user uses outdoor goods or services, or accesses outdoor information at least three hours a week. When making recommendations to the user therefore, the content customization module 312 can determine that goods, services, and information targeted to outdoor enthusiasts are pertinent to the user.

Certainly a user can be associated with multiple different marketing segments based on the object usage statistics 308, information contained in a user profile, and so on. Thus, the goods, services, and information determined pertinent to the user can be associated with the multiple different marketing segments. In addition to the supplemental information discussed herein, the content customization module 312 can also take into account other supplemental information to determine goods, services, and information that are pertinent to a user without departing from the spirit or scope of the techniques for content targeting and recommendations based on object usage.

Using the object usage statistics 308 and supplemental information, the content customization module 312 can determine a variety of goods, services, and information pertinent to a user. For instance, the goods, services, and information determined pertinent to a user can include “replacement” goods to replace objects associated with the user, such as when the objects surpass a threshold amount of lifespan, when it is determined that the user can be “upsold” to other objects, and so on.

The goods, services, and information determined pertinent to a user can also include supplemental goods to supplement the goods used or purchased by the user, e.g., those determined likely to provide a benefit to the user if used in conjunction with the objects associated with the user, those the user is determined likely to purchase based on both the objects associated with the user as well as usage of the associated objects. Information that is determined pertinent to a user can also supplement the objects a user uses. By way of example, if groceries purchased by a user are tracked and packaged with sensors to indicate the food a user still has available in his or her kitchen, e.g., sensors of food in a refrigerator can indicate whether food remains and also whether it is to be consumed within a certain number of days. The object usage statistics 308 indicative of food available (and of food to be eaten soon) can be used to recommend information such as recipes to the user.

Once the pertinent goods, services, or information is determined, the content customization module 312 generates the recommendations 316 that suggest the pertinent goods, services, or information. As part of doing so, the content customization module 312 configures content corresponding to the recommendations 316. For example, the content customization module 312 configures a recommendation as an email, a text, a banner advertisement, an electronic billboard display, and so on. The content customization module 312 is capable of generating the recommendations 316 by configuring them to include a variety of content, such as customized text, images, videos, and so on.

After the content customization module 312 generates the recommendations 316, they are communicated for presentation to a user. The recommendations 316 can be communicated over the network 116, for example. Once received, the recommendations 316 can be presented to the user via the modes of deliver 314. The recommendations 316 can be presented to a user in a variety of ways, such as presented via a mobile phone associated with the user (e.g., through text, email, voice call, voice message, link to a web page, as a commercial played while the user listens to music or watches programming on the mobile phone, and so on), presented via another device (e.g., tablet device, computing device associated with the user, the GPS receiver 112, and so on), presented via an object used and related to the recommendations 316 (e.g., on a display of the fishing rod 106 in the example fishing scenario), and so forth.

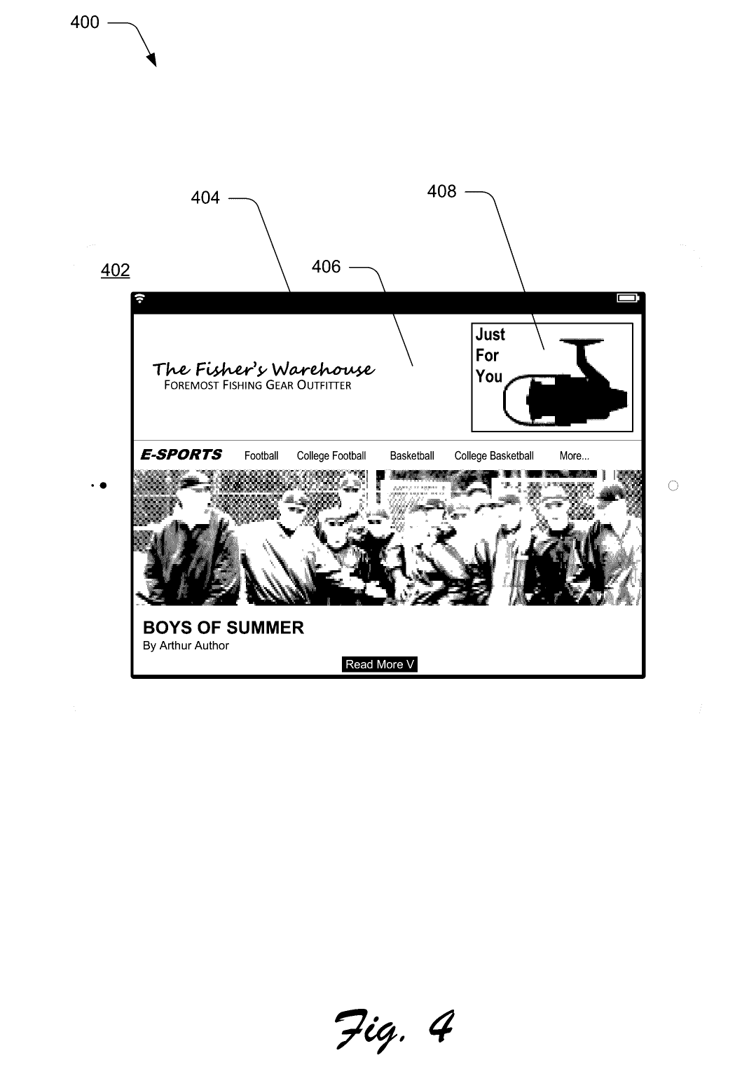

FIG. 4 depicts an example at 400 of a user interface that is generated to present a recommendation that suggests a good, service, or information determined pertinent to a user based on usage of the objects with which the user is associated. In particular, FIG. 4 includes a computing device 402 which is depicted displaying user interface 404. In this example, the user interface 404 corresponds to a web browser that displays a web page. At the top of the web page is recommendation 406. The recommendation 406 in this example is configured as a banner advertisement, which is generated to suggest good 408.

Considered in conjunction with the example fishing scenario, the recommendation 406 can be generated to suggest good 408 to a user based, at least in part, on the object usage statistics 308, which describe the user's use of the boat 104, the fishing rod 106, the fishing reel 108, the lure 110, and the GPS receiver 112. For instance, the recommendation can be generated to suggest good 408 to replace the fishing reel 108 because the fishing reel 108 is nearing an end of its observed lifespan. Alternately, the recommendation 406 can be generated to suggest good 408 to supplement the fishing reel 108 because it is determined that the user is likely to benefit from having another fishing reel, e.g., it enables the user to save time when reconfiguring the fishing rod 106 for catching different types of fish, it enables the user to use different types of lures in addition to the lure 110, and so on.

Although the techniques of content targeting and recommendations based on object usage are generally described herein as being performed by a service provider (e.g., one implemented in part by the computing device 102), in one or more implementations the techniques can be performed without involving the service provider. For example, an object of the IoT may be capable of maintaining information about an amount it is used, as well as information about its lifespan. In this example, when use of the object surpasses some threshold amount of use (e.g., corresponding to a predetermined aggregated time of use, a predetermined number of uses, a predetermined amount of time since purchase, and so on), the object can notify the user that the threshold amount of use has been surpassed. The object can be configured with LEDs, for instance, that light up when the threshold amount of use has been surpassed. Alternately or in addition, the object can communicate a notification to a device associated with a user, such as to a mobile phone of the user, indicating that the threshold amount of time has been surpassed.

In one example, a pair of running shoes may have a predetermined lifespan, such as five-hundred miles. The sensors 114 of the shoes (as well as other objects associated with the user) can detect how far a user has run or walked in the shoes and maintain data indicative of that distance. When the sensors 114 detect that the shoes have been run in or walked in for 500 miles, the sensors 114 can cause the user to be notified that the shoes have surpassed a lifespan of the shoes. If the shoes are configured with LEDs, for example, the LEDs can light up indicating that the lifespan has been surpassed. Alternately or in addition, the sensors 114 can cause a notification (e.g., a text message) to be pushed to a mobile device also associated with the user to inform the user that the lifespan has been surpassed.

In another example, a mobile phone associated with a user can communicate directly with a display (e.g., an electronic billboard, in-store display, and so on) that is configured to display targeted content and recommendations to users of the IoT. In this scenario, the display can be configured to “listen” for devices connected to the IoT, such as the mobile phone of the user. To do so, the display can be on an open listening port of a communication protocol which allows the display to listen for other devices. When the mobile phone of the user is proximate the display (e.g., within a threshold distance of the display), the mobile phone can detect that there is a display close by capable of displaying targeted content and recommendations. In some scenarios the mobile phone can receive context information from the display or can generate the context information based on location. Regardless of whether it does so, the mobile phone can also pull down targeted content and recommendations from the content targeting and rec. module 126. The mobile phone can then communicate the targeted content and recommendations to the display, where they are displayed to the user when the user is determined to be nearby.

Having discussed example details of the techniques for content targeting and recommendations based on object usage, consider now some example procedures to illustrate additional aspects of the techniques.

Example Procedures

This section describes example procedures for content targeting and recommendations based on object usage in one or more implementations. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures are performed by a suitably configured device, such as the example computing device 102 of FIGS. 1 and 2 or one implemented as the example system 300 of FIG. 3 that make use of an object usage analysis module 124 and a content targeting and rec. module 126.

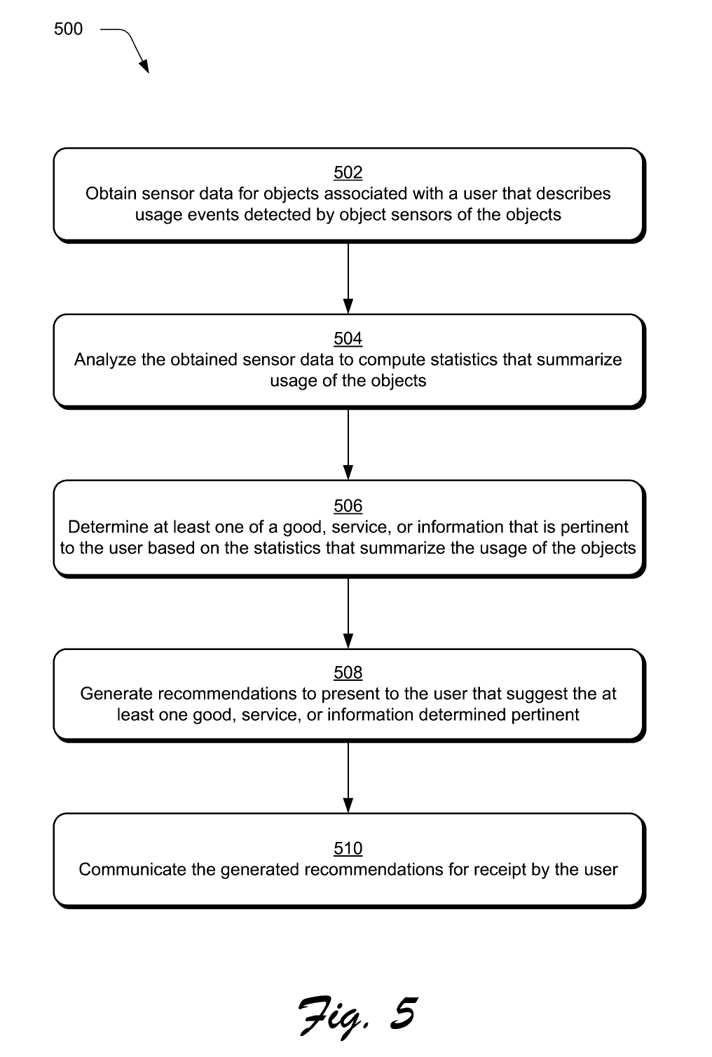

FIG. 5 depicts an example procedure 500 in which sensor data is obtained for objects associated with a user that describes usage of the objects, and in which recommendations are generated for the user based on the usage. The example procedure 500 is implemented in a digital medium environment (e.g., the Internet of Thing (IoT)) in which sensors are included as part of objects, detect usage events that result from object usage, and produce sensor data indicative of the events. To generate the recommendations, sensor data is obtained for objects associated with a user that describes usage events detected by object sensors of the objects (block 502). For example, the computing device 102 obtains the sensor data 122 that is produced by the sensors 114 for objects associated with a user. The sensor data describes the usage events detected by the sensors 114 that occur as a result of using the objects.

In the example fishing scenario, the computing device obtains the sensor data 122 that is produced by the sensors 114 of the boat 104, the fishing rod 106, the fishing reel 108, the lure 110, and the GPS receiver 112, and which describes the usage events detected by the sensors 114 that occur as a result of using these objects.

The obtained sensor data is analyzed to compute statistics that summarize usage of the objects (block 504). For example, the object usage analysis module 124 analyzes the sensor data 122 to compute the object usage statistics 308. With regard to the continuing example fishing scenario, the object usage analysis module 124 analyzes the sensor data 122 that describes the use of the boat 104, the fishing rod 106, the fishing reel 108, the lure 110, and the GPS receiver 112 to compute the object usage statistics 308 that describes the usage of these objects. By way of example, the object usage statistics 308 can describe an amount of use of the boat 104, the fishing rod 106, the fishing reel 108, the lure 110, and the GPS receiver 112. With regard to the fishing rod 106 in particular, the object usage statistics 308 can describe a number of times the rod was cast, a number of times or a percentage of the times the casts resulted in success (e.g., catching a fish), and so on.

Based on the statistics that summarize the usage of the objects, at least one of a good, a service, or information is determined pertinent to the user (block 506). For example, the content targeting and rec. module 126 employs the content customization module 312 to determine what goods, services, and information are pertinent to the user based on the object usage statistics 308. As described in more detail above, a determination as to pertinent goods, services, and information can involve not only the object usage statistics 308 but also a variety of other supplemental information. With reference again to the example fishing scenario, based on the object usage statistics 308 that summarize the usage of the objects in that scenario, the content customization module 312 determines what goods, services, and information are pertinent to the user associated with those objects. For example, the good 408 is determined pertinent to the user based on the object usage statistics 308 for the objects in the example fishing scenario.

Recommendations are generated to present to the user (block 508). The generated recommendations suggest the at least one good, service, or information that is determined pertinent to the user. For example, the content targeting and rec. module 126 employs the content customization module 312 to generate the recommendations 316, which suggest the at least one good, service, or information determined pertinent to the user at block 506. In the continuing example, the content targeting and rec. module 126 generates the recommendation 406 which suggests the good 408 to the user in a banner advertisement for a web page.

The generated recommendations are communicated for receipt by the user (block 410). For example, the content targeting and rec. module 126 communicates the recommendations 316 to the user via the network 116. With reference again to the example fishing scenario, the content targeting and rec. module 126 communicates the recommendation 406 configured as the banner advertisement for display as part of a web page requested by the user. The recommendation 406 can then be presented to the user via a device associated with the user, such as via a display of the computing device 402.

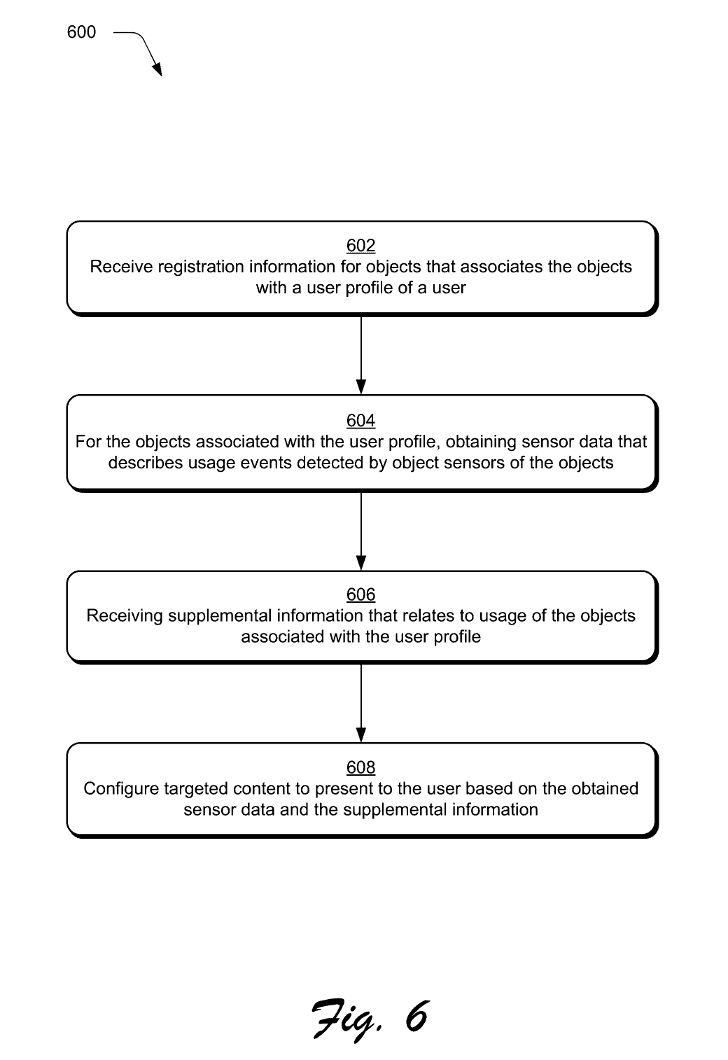

FIG. 6 depicts an example procedure 600 in which targeted content is configured for presentation to a user based on usage of objects associated with a user profile of the user as well as supplemental information that is determined related to the usage of the objects. Like the example procedure 500, the example procedure 600 is also implemented in a digital media environment such as the IoT. Registration information is received for objects to associate them with a user profile of a user (block 602). For example, a service provider implemented at least in part by the computing device 102 receives registration information to associate objects with a user profile of a user.

With regard to the example fishing scenario, the computing device 102 receives registration information to associate the boat 104, the fishing rod 106, the fishing reel 108, the lure 110, and the GPS receiver 112 with a user. By way of example, the user scans bar- or QR-codes of these objects using a mobile phone, and an application of the mobile phone causes the objects to be registered with the service provider. Additionally or alternately, the registration information can be provided to the service provider automatically in conjunction with purchase of the objects, such as when the objects are bought online, when a credit card associated with the user profile of the user is used to purchase the objects, and so on.

For the objects associated with the user profile, sensor data is obtained that describes usage events detected by object sensors of the objects (block 604). For example, the object usage analysis module 124 obtains the sensor data 122 in a similar manner as at block 504. In addition to the sensor data, supplemental information is received that relates to usage of the objects associated with the user profile (block 606). For example, the content targeting and rec. module 126 receives supplemental information that is related to the usage of the objects associated with the user profile. As described in more detail above, the supplemental information can describe a variety of aspects that relate to usage of the objects, such as a location of an object when it was used, the weather at the location of use, user profile information of other users determined similar to the user, marketing information, and so on.

Based on the obtained sensor data and the supplemental information, targeted content is configured to present to the user (block 608). For example, the content customization module 312 configures targeted content for presentation to a user based on both the object usage statistics 308 and the supplemental information received at block 606. When the supplemental information corresponds to marketing information, such as marketing segments and an indication of how user profiles are to be classified into different marketing segments based on object use, the content customization module 312 configures targeted marketing content based on both the marketing information and the object usage statistics 308. This provides the advantage to marketers of being able to target individuals for goods and services based on the way the individuals actually use objects. This represents an improvement over conventional marketing techniques that target content to users solely based on online purchases and demographic information, but fail to account for purchases made offline and the way individuals actually use the goods and services the individuals purchase.

Having described example procedures in accordance with one or more implementations, consider now an example system and device that can be utilized to implement the various techniques described herein.

Example System and Device

FIG. 7 illustrates an example system generally at 700 that includes an example computing device 702 that is representative of one or more computing systems and/or devices that implement the various techniques described herein. This is illustrated through inclusion of the content targeting and rec. module 126, which operates as described above. The computing device 702 may be, for example, a server of a service provider, a device associated with a client (e.g., a client device), an on-chip system, and/or any other suitable computing device or computing system.

The example computing device 702 includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 702, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that is employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules are implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software are achieved at least partially in hardware, e.g., through use of computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device implementation, implementation of functionality described herein is distributed throughout the system 700. For example, the functionality is implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment in which sensors are included as part of objects, detect usage events that result from object usage, and produce sensor data indicative of the usage events, a method implemented by one or more computing devices to generate recommendations that are based on the object usage, the method comprising:
obtaining the sensor data, by the one or more computing devices, for one or more objects associated with a user that describes the usage events detected by object sensors of the one or more objects;
analyzing the obtained sensor data to compute statistics that summarize usage of the one or more objects;
generating one or more recommendations to present to the user, the one or more recommendations suggesting at least one of a good, a service, or information determined pertinent to the user based on the statistics that summarize the usage of the one or more objects; and
communicating the generated one or more recommendations by the one or more computing devices for receipt by the user.

2. A method as described in claim 1, further comprising determining the at least one good, service, or information that is pertinent to the user based on the statistics that summarize the usage of the one or more objects.

3. A method as described in claim 1, wherein the one or more computing devices correspond to a service provider with which the user has an associated profile, the service provider configured to associate objects with the user via the profile.

4. A method as described in claim 1, further comprising receiving registration information for the one or more objects that associates the one or more objects with the user.

5. A method as described in claim 1, wherein the sensor data is obtained from a hub device configured to aggregate the sensor data from the object sensors of the one or more objects prior to the sensor data being obtained.

6. A method as described in claim 1, wherein the statistics that summarize the usage of the one or more objects indicate an amount the one or more objects are used.

7. A method as described in claim 6, wherein generating the one or more recommendations involves configuring the one or more recommendations with content that indicates one or more goods to replace the one or more objects when the amount the one or more objects are used surpasses a threshold amount of use.

8. A method as described in claim 1, wherein generating the one or more recommendations involves configuring the one or more recommendations with content that indicates one or more supplemental goods or services when the statistics that summarize the usage of the one or more objects are determined to indicate the user is likely to benefit from using the one or more supplemental goods or services in conjunction with the one or more objects.

9. A method as described in claim 1, wherein generating the one or more recommendations involves configuring the one or more recommendations with content that indicates one or more supplemental goods or services when the statistics that summarize the usage of the one or more objects are determined to indicate the user is likely to purchase the one or more supplemental goods or services.

10. A method as described in claim 1, further comprising determining an interface that is associated with the user via which to present the one or more recommendations, the determined interface being included as part of one of the one or more objects and the recommendations being configured for presentation via the determined interface of the one object.

11. A method as described in claim 1, further comprising determining an interface that is associated with the user via which to present the one or more recommendations, the determined interface being included as part of a device configured to present the content to the user and not corresponding to the one or more objects for which the statistics that summarize the usage are computed.

12. A system implemented in a digital medium environment in which sensors are included as part of objects, detect usage events that result from object usage, and produce sensor data indicative of the usage events, the system configured to generate and deliver recommendations to users based on the object usage, the system comprising:
one or more processors; and
memory having stored thereon instructions that are executable by the one or more processors to implement a service provider to perform operations comprising:
receiving registration information to associate an object with a user profile that is maintained by the service provider, the object configured with one or more object sensors to detect the usage events;
obtaining the sensor data that describes the usage events detected by the one or more object sensors;
receiving supplemental information that originates from a data source other than the one or more object sensors and is determined related to the obtained sensor data;
determining that at least one of a good, a service, or information is pertinent to a user associated with the user profile based on the obtained sensor data and the supplemental information; and
generating one or more recommendations to present to the user, including configuring the one or more recommendations with content to suggest the at least one good, service, or information that is determined pertinent.

13. A system as described in claim 12, wherein the supplemental information is determined to be related to the usage events based on at least one of:
a time associated with detection of the usage events;
a location of the object when the usage events are detected;
different objects associated with the user profile; and
a similarity between information associated with the user profile and information associated with one or more other user profiles maintained by the service provider.

14. A system as described in claim 12, wherein the supplemental information includes at least one of:
weather data indicative of weather at a location where the object is determined to be used;
user profile data associated with other user profiles maintained by the service provider and that are determined similar to the user profile; and
segment data that indicates one or more marketing segments to associate with the user profile according to usage of the object as indicated by the obtained sensor data.

15. A system as described in claim 12, wherein:
the operations further comprise associating the user profile with one or more marketing segments according to usage of the object as indicated by the obtained sensor data;
the supplemental information comprises segment data that indicates the one or more marketing segments; and
the one or more recommendations are generated based on the one or more marketing segments associated with the user profile.

16. In a digital medium environment in which sensors are included as part of objects, detect usage events that result from object usage, and produce sensor data indicative of the usage events, a method implemented by a client device to make recommendations to users based on the object usage, the method comprising:
receiving one or more recommendations by the client device, the one or more recommendations suggesting at least one of a good, a service, or information that is determined pertinent to a user based on usage of one or more objects associated with the user, the usage described by sensor data obtained from object sensors of the one or more objects; and
outputting the one or more recommendations by the client device for presentation to the user.

17. A method as described in claim 16, wherein the client device is configured with a display and the one or more recommendations are output for presentation to the user via the display.

18. A method as described in claim 16, wherein the one or more recommendations are received from a service provider configured to generate the one or more recommendations.

19. A method as described in claim 16, wherein the one or more recommendations are received from the one or more objects the usage of which serves as the basis for determining the at least one pertinent good, service, or information.

20. A method as described in claim 16, wherein the one or more recommendations include at least one of:
content indicating one or more goods to replace the one or more objects the usage of which serves as a basis for determining the at least one pertinent good, service, or information;
content indicating one or more supplemental goods or services that the user is determined likely to benefit from based on the usage of the one or more objects that serves as the basis for determining the at least one pertinent good, service, or information; or
content indicating one or more supplemental goods or services that the user is determined likely to purchase based on the usage of the one or more objects that serves as the basis for determining the at least one pertinent good, service, or information.
